(19) United States
(12) Patent Application Publication
(10) Pub. No.: US 2008/0170395 A1
(43) Pub. Date: Jul. 17, 2008

(54) DOUBLE LIGHT MODULE

(75) Inventor: Wen-Ching HO, Hsinchu (TW)

Correspondence Address: SHERIDAN ROSS PC, 1560 BROADWAY, SUITE 1200, DENVER, CO, 80202, US

(73) Assignee: CORETRONIC CORPORATION, Hsinchu (TW)

(21) Appl. No.: 11/850,553

(22) Filed: Sep. 5, 2007

(30) Foreign Application Priority Data
Jan. 11, 2007 (TW) 096101072

(51) Int. Cl. F21V 1/00

(52) U.S. Cl. 362/240

(57) ABSTRACT

A double light module includes a lamp seat and two illuminating units. The lamp seat includes a mounting frame formed with a through hole. The illuminating units are mounted to the mounting frame corresponding to the through hole. Each of the illuminating units includes a lamp cover and a lamp wick disposed in the lamp cover. The lamp cover includes a cover body that has three mounting peripheral segments and one abutting peripheral segment, and three mounting portions that are provided respectively at the mounting peripheral segments and that are mounted to the mounting frame adjacent to the through hole. The abutting peripheral segment of one of the lamp covers abuts against the abutting peripheral segment of the other one of the lamp covers.

### CROSS-REFERENCE TO RELATED APPLICATION

This application claims priority of Taiwanese Application No. 096101072, filed on Jan. 11, 2007.

### BACKGROUND OF THE INVENTION

1. Field of the Invention

The invention relates to a light module, more particularly to a double light module.

2. Description of the Related Art

When an ultra high pressure mercury lamp is used as a light source of a projector, and when it is desired for images projected by the projector to have high brightness, it is necessary for the ultra high pressure mercury lamp to be a high power one. However, since an ultra high pressure mercury lamp at present only has a highest power of 300 watts, luminance provided by a single ultra high-pressure mercury lamp is fairly limited. Therefore, higher image brightness in projectors is often achieved by increasing the number of ultra high pressure mercury lamps employed. Consequently, some projectors include a double light module that includes two ultra high pressure mercury lamps to serve as a light source thereof.

Moreover, in order to minimize the size of the projector, the two ultra high pressure mercury lamps of the double light module are often closely arranged. However, as shown in FIG. 1, a lamp cover 110 of a conventional ultra high pressure mercury lamp 11 is so shaped such that four mounting portions 112 are disposed at four corners of a cover body 111 thereof. Therefore, prior to assembling a conventional double light module utilizing the conventional ultra high pressure mercury lamps 11, part of the lamp cover 110 of each conventional ultra high pressure mercury lamp 11 is cut off so as to reduce the size of the conventional double light module.

Prior to assembling the conventional double light module, as shown in FIG. 2 and FIG. 3, each of the conventional ultra high pressure mercury lamps 11 is disposed in such a way that a square formed by the mounting portions 112 is upright. Then, a side of the lamp cover 110 is cut off along the dotted line shown in FIG. 2 such that only two of the mounting portions 112 remain. Subsequently, to assemble the conventional double light module, peripheries at the cut-off side of the lamp covers 110 of the conventional ultra high pressure mercury lamps 11 are disposed to abut closely together. Since each of the conventional ultra high pressure mercury lamps 11 has only two remaining mounting portions 112 for fixing onto a mounting frame (not shown) of the conventional double light module, the conventional ultra high pressure mercury lamps 11 are not effectively and securely fixed such that wobbling of the same usually occurs.

### SUMMARY OF THE INVENTION

Therefore, the object of the present invention is to provide a double light module including illumination units that is securely fixed.

According to the present invention, a double light module is provided and includes a lamp seat and two illuminating units. The lamp seat includes a mounting frame formed with a through hole. The illuminating units are mounted to the mounting frame corresponding to the through hole. Each of the illuminating units includes a lamp cover and a lamp wick disposed in the lamp cover. The lamp cover includes a cover body that has three mounting peripheral segments and one abutting peripheral segment, and three mounting portions that are provided respectively at the mounting peripheral segments and that are mounted to the mounting frame adjacent to the through hole. The abutting peripheral segment of the cover body of the lamp cover of one of the illuminating units abuts against the abutting peripheral segment of the cover body of the lamp cover of the other one of the illuminating units.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

Other features and advantages of the present invention will become apparent in the following detailed description of the preferred embodiment with reference to the accompanying drawings, of which:

FIG. 1 is a stereogram of a conventional ultra high pressure mercury lamp;

FIG. 2 is a front schematic view of the conventional ultra high pressure mercury lamp;

FIG. 3 is a stereogram of a conventional ultra high pressure mercury lamp, after a lamp cover thereof has been partly cut off;

FIG. 4 is an exploded stereogram of a preferred embodiment of a double light module according to the present invention;

FIG. 5 is a front schematic view of an initial lamp cover for forming an illuminating unit of the double light module according to the preferred embodiment of the present invention;

FIG. 6 is a stereogram of the assembly of the double light module according to the preferred embodiment of the present invention;

FIG. 7 is a stereogram of the assembly of the double light module according to the preferred embodiment of the present invention; and

FIG. 8 is a partly exploded stereogram, illustrating mounting of the double light module according to the preferred embodiment of the present invention to an optical engine.

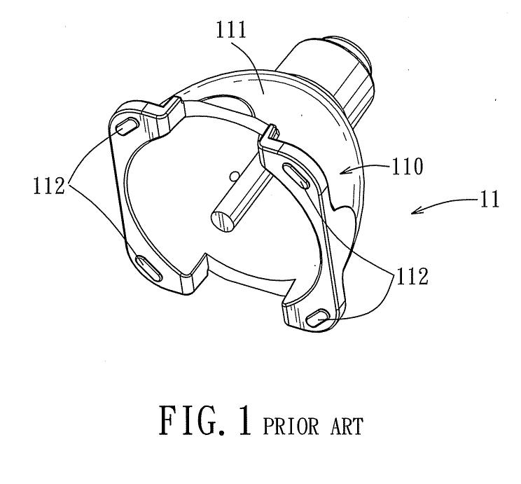

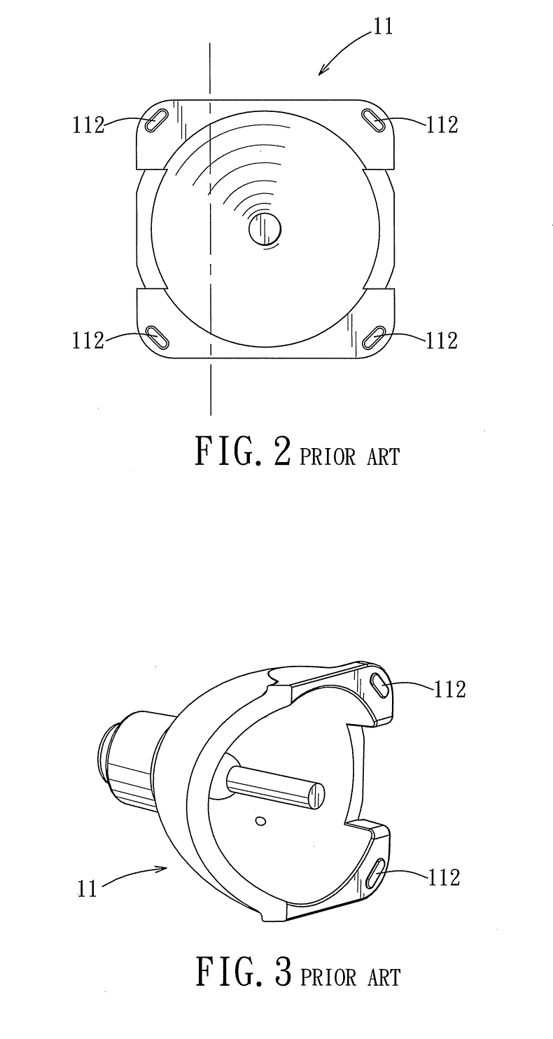

### DETAILED DESCRIPTION OF THE PREFERRED EMBODIMENT

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

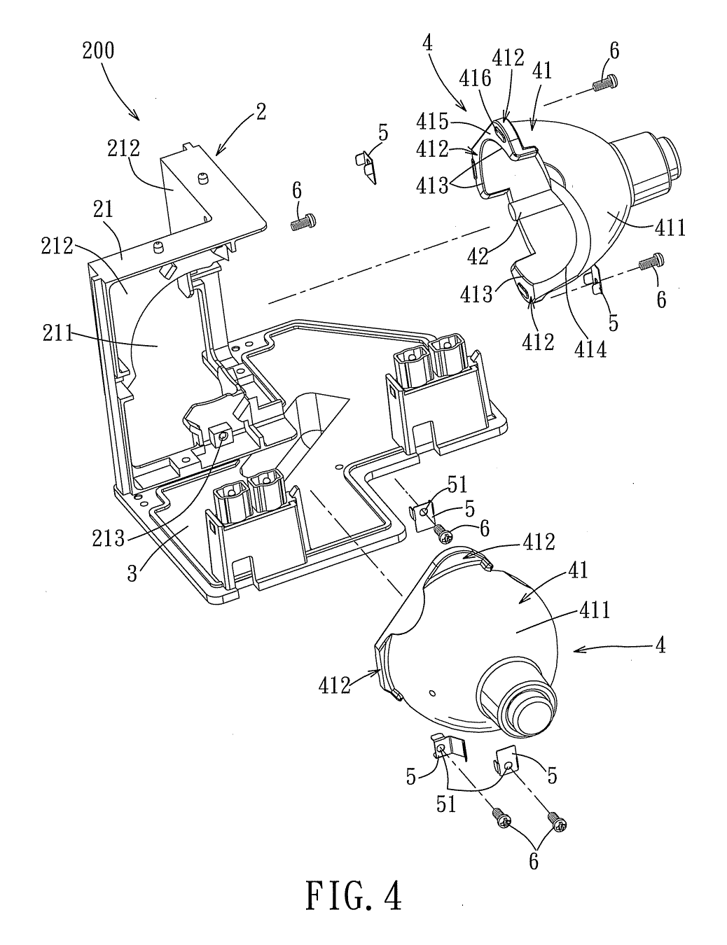

Referring to FIG. 4, the preferred embodiment of a double light module 200 according to the present invention includes a lamp seat 2, a base 3, and two illuminating units 4. The lamp seat 2 includes a mounting frame 21 formed with a through hole 211. In this embodiment, the mounting frame 21 includes two plate portions 212 connected to each other at a right angle, and respectively formed with a cutout. The cutouts of the plate portions 212 communicate spatially with each other so as to form the through hole 211 in the mounting frame 21. The base 3 extends integrally from one end of the mounting frame 21 at an angle.

The illuminating units 4 are mounted to the mounting frame 21 and corresponding to the through hole 22. Each of the illuminating units 4 includes a lamp cover 41 and a lamp wick 42 disposed in the lamp cover 41. The lamp cover 41 includes a curved cover body 411 and three mounting portions 412. The cover body 411 has three mounting peripheral segments 413 and one abutting peripheral segment 414. The mounting portions 412 are provided respectively at the mounting peripheral segments 413 and are mounted to the mounting frame 21 adjacent to the through hole 211 such that the lamp cover 41 is coupled to the mounting frame 21. Each of the mounting portions 412 includes a plate part 415 and a protrusion 416. The plate part 415 of each of the mounting portions 412 extends radially outward from the respective one of the mounting peripheral segments 413, while the protrusion 416 projects from the plate part 415. In this embodiment, geometric centers of the mounting portions 412 of the lamp cover 41 of each of the illuminating units 4 cooperate to define a right-angled triangle. In addition, the lamp wick 42 includes an ultra high pressure mercury lamp, while the lamp cover 41 has either an ellipsoid shape or a parabolic shape. A plane defined by the mounting peripheral segments 413 of the cover body 411 of the lamp cover 41 of one of the illuminating units 4 is perpendicular to a plane defined by the mounting peripheral segments 413 of the cover body 411 of the lamp cover 41 of the other one of the illuminating units 4. It is noted herein that the relative placement of the lamp covers 41 of the illuminating units 4 is not limited to that disclosed in this embodiment, i.e., the planes do not have to be perpendicular to each other, as long as the planes form an angle therebetween such that light beams provided by the illuminating units 4 converge.

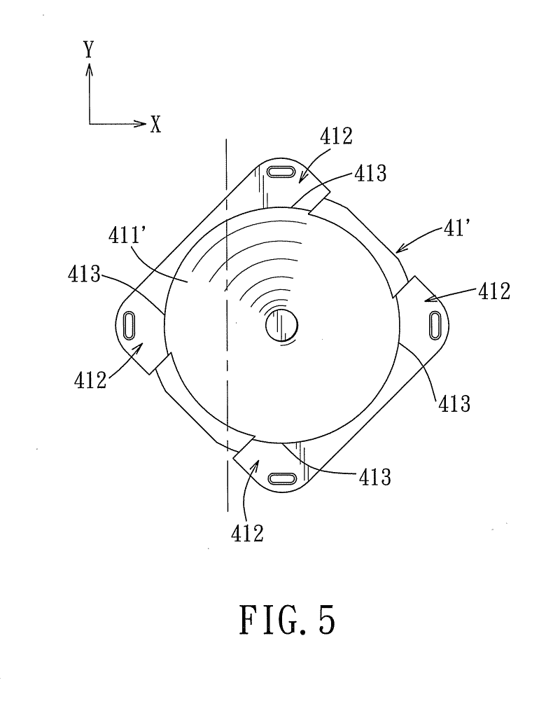

As shown in FIG. 5, formation of the lamp cover 41 by way of cutting an initial lamp cover 41′ will be described hereinafter. The initial lamp cover 41′ includes a cover body 411′ that has four of the mounting peripheral segments 413 of the present invention and none of the abutting peripheral segment 414 of the present invention. The initial lamp cover 41′ further includes four of the mounting portions 412, and each of the mounting portions 412 is provided at a corresponding one of the mounting peripheral segments 413. Firstly, the initial lamp cover 41′ is disposed in such a way that each of four sides of a square formed by the mounting portions 412 forms a 45 degree angle relative to a first axis (X). The initial lamp cover 41′ is then cut at a corner in the direction of a second axis (Y) perpendicular to the first axis (X) along the dotted line shown in FIG. 5, so as to result in the lamp cover 41 (as shown in FIG. 4) of the embodiment of the present invention that includes three of the mounting portions 412.

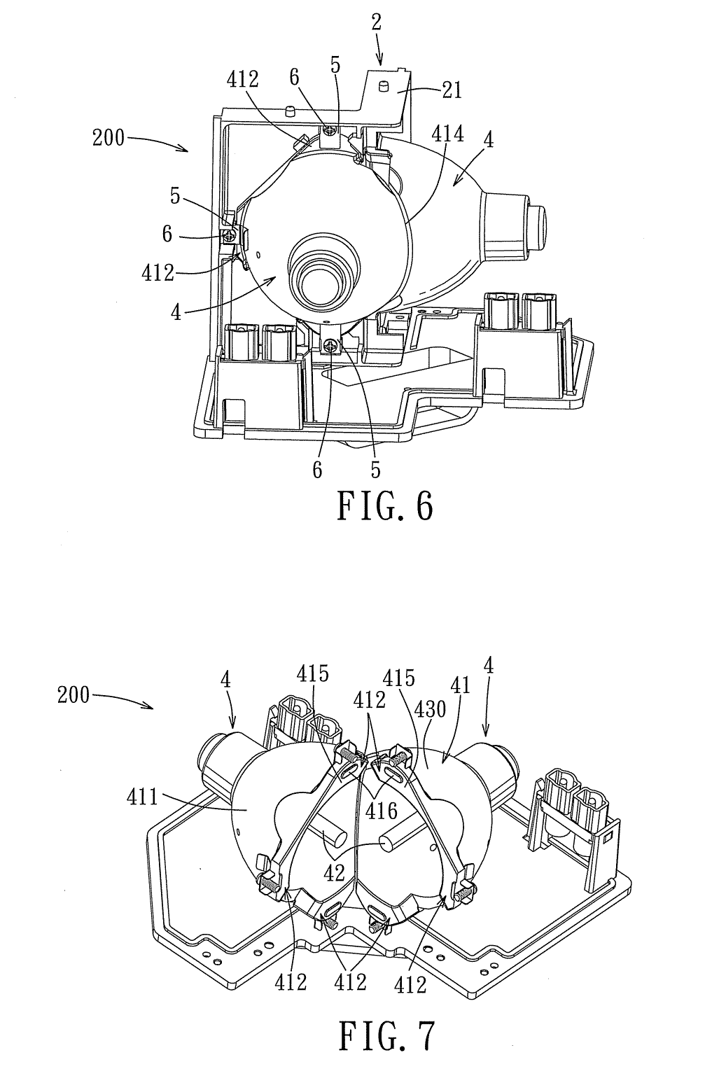

Referring to FIG. 4 and FIG. 6, the double light module 200 further includes six washers 5 and six screw fasteners 6. Each of the washers 5 is formed with an opening 51. The mounting frame 21 is formed with six fastener holes 213 adjacent to the through hole 211. Each of the mounting portions 412 of the lamp covers 41 of the illuminating units 4 is disposed between the mounting frame 21 and a corresponding one of the washers 5. Each of the screw fasteners 6 extends through the opening 51 in a corresponding one of the washers 5 and engages threadedly a corresponding one of the fastener holes 213 in the mounting frame 21 such that a corresponding one of the mounting portions 412 is clamped between the mounting frame 21 and the corresponding one of the washers 5, thereby securing the illuminating units 4 to the mounting frame 21. However, the illuminating units 4 are not limited to be secured to the mounting frame 21 in the manner described above.

As shown in FIG. 6 and FIG. 7, to assemble the double light module 200, the illuminating units 4 are brought closely together such that the abutting peripheral segment 414 of the cover body 411 of the lamp cover 41 of one of the illuminating units 4 abuts against the abutting peripheral segment 414 of the cover body 411 of the lamp cover 41 of the other one of the illuminating units 4. Subsequently, the lamp covers 41 are disposed such that the mounting portions 412 are respectively aligned with the fastener holes 213 in the mounting frame 21 of the lamp seat 2. Next, the washers 5 are disposed respectively on sides of the plate parts 415 of the mounting portions 412 not formed with the projections 416, and are respectively aligned with the fastener holes 213. Lastly, each of the screw fasteners 6 is extended through the opening 51 in the corresponding one of the washers 5 and is engaged threadedly with the corresponding one of the fastener holes 213 in the mounting frame 21 such that the corresponding one of the mounting portions 412 is clamped between the mounting frame 21 and the corresponding one of the washers 5, thereby completing the assembly of the double light module 200. Since the abutting peripheral segments 414 of the cover bodies 411 of the lamp covers 41 abut against each other, the size of the double light module 200 is reduced.

As described hereinabove, since only one cutting process is required, the formation of the illuminating units 4 is as simple as that of the prior art. In addition, since each of the illuminating units 4 includes three mounting portions 412 for mounting of the illuminating unit 4, the illuminating unit 4 is mounted more securely to the mounting frame 21 of the lamp seat 2 as compared to the prior art.

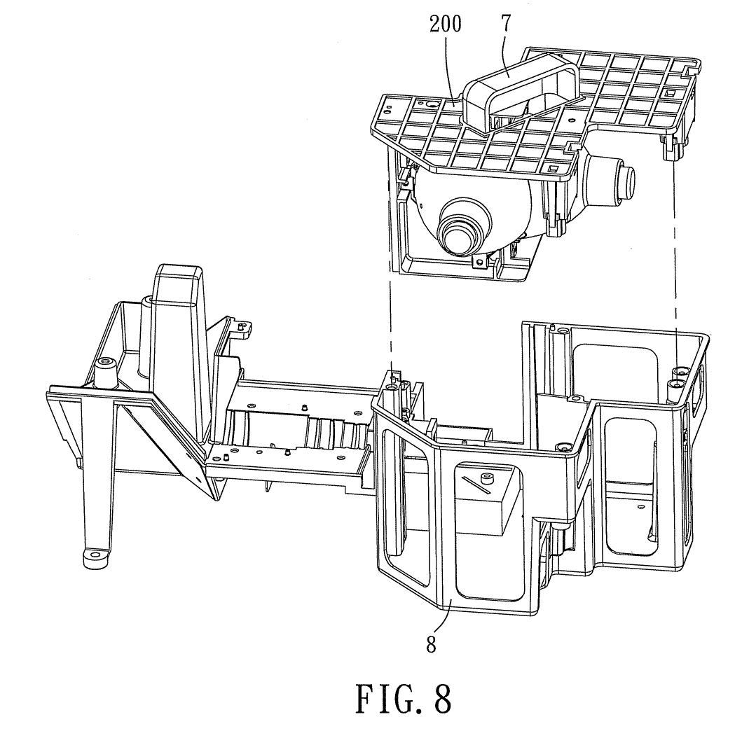

As shown in FIG. 8, the assembled double light module 200 is mounted removably in an optical engine. In this embodiment, the double light module 200 is designed to be inserted downwardly into a housing 8 of the optical engine. However, other designs are also acceptable as to the mounting of the double light module 200 into the optical engine. Moreover, the double light module 200 further includes a handle 7 disposed at a side of the base 3 opposite to the mounting frame 21. Maintenance personnel conveniently remove and replace the double light module 200 by gripping at the handle 7.

It is noted herein that the aforementioned cutting method serves solely to provide an illustrative example for the formation of the illuminating unit 4, and should not be taken to limit the scope of the present invention. What is important is that the cover body 411 of the lamp cover 41 should be provided with three mounting peripheral segments 413.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the terms “the invention”, “the present invention” or the like do not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element or component in the present disclosure is intended to be dedicated to the public regardless of whether the element or component is explicitly recited in the following claims.

What is claimed is:

1. A double light module comprising:
a lamp seat including a mounting frame formed with a through hole; and
two illuminating units mounted to the mounting frame and corresponding to the through hole, each of the illuminating units including a lamp cover and a lamp wick disposed in the lamp cover, the lamp cover including a cover body that has three mounting peripheral segments and one abutting peripheral segment, and three mounting portions that are provided respectively at the mounting peripheral segments and that are mounted to the mounting frame adjacent to the through hole, the abutting peripheral segment of the cover body of the lamp cover of one of the illuminating units abutting against the abutting peripheral segment of the cover body of the lamp cover of the other one of the illuminating units.

2. The double light module as claimed in claim 1, wherein geometric centers of the mounting portions of the lamp cover of each of the illuminating units cooperate to define a right-angled triangle.

3. The double light module as claimed in claim 1, wherein the illuminating unit includes an ultra high pressure mercury lamp.

4. The double light module as claimed in claim 1, wherein the lamp cover has an ellipsoid shape.

5. The double light module as claimed in claim 1, wherein the lamp cover has a parabolic shape.

6. The double light module as claimed in claim 1, wherein a plane defined by the mounting peripheral segments of the lamp cover of one of the illuminating units is perpendicular to a plane defined by the mounting peripheral segments of the lamp cover of the other one of the illuminating units.

7. The double light module as claimed in claim 1, wherein the mounting frame includes two plate portions connected to each other at a right angle, and respectively formed with a cutout, the cutouts of the plate portions communicating spatially with each other so as to form the through hole in the mounting frame.

8. The double light module as claimed in claim 1, further comprising six washers and six screw fasteners, each of the washers being formed with an opening, the mounting frame being formed with six fastener holes adjacent to the through hole, each of the mounting portions of the lamp covers of the illuminating units being disposed between the mounting frame and a corresponding one of the washers, each of the screw fasteners extending through the opening in a corresponding one of the washers and engaging threadedly a corresponding one of the fastener holes in the mounting frame such that a corresponding one of the mounting portions is clamped between the mounting frame and the corresponding one of the washers.

9. The double light module as claimed in claim 1, wherein the mounting frame comprises two plate portions connected to each other, and the double light module further comprises a base extending integrally from one end of the mounting frame at an angle.

10. The double light module as claimed in claim 9, further comprising a handle disposed at a side of the base opposite to the mounting frame.
